(19) United States
(12) Patent Application Publication
(10) Pub. No.: US 2005/0190948 A1
(43) Pub. Date: Sep. 1, 2005

(54) Method of embedding a digital watermark and a digital watermark embedding apparatus

(76) Inventor: Taichi Isogai, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/017,919

(22) Filed: Dec. 22, 2004

(30) Foreign Application Priority Data
Dec. 26, 2003 (JP) 2003-432230

(51) Int. Cl. G06K 9/00

(52) U.S. Cl. 382/100

(57) ABSTRACT

A plurality of areas are specified in an original image in which a digital watermark is to be embedded. The areas are classified into embedding areas in which watermark information is to be embedded and specification areas in which another area is to be specified. A plurality of areas are again specified in the specification areas and these areas are classified as embedding areas. Watermark information is input and each watermark is generated based on the size and shape of the each embedding area, and the digital watermarks are arranged in positions indicated by the embedding areas and embedded into the original image.

### CROSS-REFERENCE TO RELATED APPLICATIONS

This application is based upon and claims the benefit of priority from prior Japanese Patent Application No. 2003-432230, filed Dec. 26, 2003, the entire contents of which are incorporated herein by reference.

### BACKGROUND OF THE INVENTION

1. Field of the Invention

The present invention relates to a method of embedding a digital watermark and apparatus for embedding a digital watermark including the information on a copyright owner of an original digital content such as a still image comprising a single image and a moving image comprising continuous images, user identification information for discriminating a user who uses the original digital content, rights information indicating rights to use the original digital content, use condition information indicating the use conditions of the original digital content, secret information required to use the original digital content, and copy control information on copy control of the original digital content (hereinafter referred to as “watermark information”) in a state in which the image of the original digital content is not easily perceived with respect to the original data content (the data embedded is called a digital watermark), and thereafter, detecting, as required, the digital watermark from the image of the digital content in which the digital watermark is embedded, in order to perform copyright protection including use control and copy control of the original digital content as well as promote secondary use of the original digital content.

2. Description of the Related Art

Digital watermark technology is a technology which embeds a digital watermark by applying a minor change to the image of an original digital content to the extent that quality degradation is negligible. It has been proposed to apply this technology to identification of a copyright owner, proof of property rights, copy control, fingerprinting, authentication of a digital content, and monitoring of broadcasting.

An image of a digital content in which a digital watermark is embedded may suffer from an attack which prevents an embedded digital watermark from being detected by innocent detection apparatus. Thus, it is desired that the digital watermark technology should have robustness against various attacks.

There is a known method, as an attack, for preventing detection of a digital watermark by trimming an image to give rise to a loss of the embedded digital watermark. Accordingly, a method has been proposed which splits an image into predetermined size and embeds a digital watermark into each split area (e.g., Japanese Patent Laid-Open No. 2003-209678, Japanese Patent Laid-Open No. 2003-219141).

In the prior art, in order to enhance the robustness against image trimming, the split size must be small. Detection accuracy of a digital watermark increases as the volume of information on the digital watermark increases. In case a digital watermark is embedded with the same intensity as one with which the digital watermark is embedded over the entire image, the information volume used to detect a digital watermark obtained from a split area decreases in proportion to the amount of splitting, which degrades the detection accuracy of the. digital watermark.

Although this problem is solved by increasing the intensity with which the digital watermark is embedded, the degradation of the image increases by this approach. Thus it is practically difficult to embed a digital watermark with too much intensity.

The above method generally leads to a lower detection accuracy of the digital watermark. While the detection accuracy may be low in case a digital watermark is detected from a small area, it is necessary, according to the method, to detect watermark information from a small split area even in case a digital watermark is detected from an entire image or an image trimmed in a large area from the entire image. As a result, only the detection accuracy which depends on the split size is obtained for any size of image.

### BRIEF SUMMARY OF THE INVENTION

According to an embodiment of the present invention, there is provided a method of embedding a digital watermark, comprising: specifying a plurality of areas on an original image; classifying the specified areas into at least one of embedding areas in which watermark information is to be embedded and at least one of a first specification area in which an area is to be specified; specifying a plurality of areas on the first specification area; classifying at least one of the specified areas into one of the embedding areas; inputting watermark information and generating digital watermarks based on a size and a shape of said embedding areas; and embedding said digital watermarks into the original image.

According to another embodiment of the present invention, there is provided a digital watermark embedding apparatus, comprising: a first specification unit configured to specify a plurality of areas on an original image; a first classification unit configured to classify the specified areas specified by the first specification unit into at least one of embedding areas in which watermark information is to be embedded and at least one of a first specification areas in which an area is to be specified; a second specification unit configured to specify a plurality of areas on the first specification area classified by the first classification unit; a second classification unit configured to classify at least one of the specified areas specified by the second specification unit into an embedding area; a digital watermark generator configured to input watermark information and to generating digital watermarks based on a size and shape of the embedding areas; and an embedding unit configured to embed the digital watermarks generated by the digital watermark generator into the original image.

According to a further embodiment of the present invention, there is provided a computer-executed program comprising: a first program code for specifying a plurality of areas on an original image; a second program code for classifying the specified areas into at least one of embedding areas in which watermark information is to be embedded and at least one of a first specification area in which an area is to be specified; a third program code for specifying a plurality of areas on the first specification area; a fourth program code for classifying at least one of the specified areas into one of the embedding areas; a fifth program code for inputting watermark information and generating digital watermarks based on a size and a shape of said embedding areas; and a sixth program code for embedding the digital watermarks into the original image.

### BRIEF DESCRIPTION OF THE SEVERAL VIEWS OF THE DRAWING

FIG. 1 is a functional block diagram of a first digital watermark embedding apparatus according to an embodiment of the invention.

FIG. 2 is a flowchart showing the operation of the digital watermark embedding apparatus according to an embodiment of the invention.

FIG. 3 is a functional block diagram of a second digital watermark embedding apparatus according to a first example.

FIG. 4 is a flowchart showing the operation of the second digital watermark embedding apparatus according to the first example.

FIG. 5 shows an example of image splitting according to the first example.

FIG. 6 is a functional block diagram of a third digital watermark embedding apparatus according to a second example.

FIG. 7 is a flowchart showing the operation of the third digital watermark embedding apparatus according to the second example.

FIG. 8 shows an example of an image according to the second example.

### DETAILED DESCRIPTION OF THE INVENTION

An embodiment of the present invention will now be described with reference to the accompanying drawings.

The digital watermark system is used to perform copyright protection including use control and copy control as well as promotion of secondary use. The digital watermark system includes: digital watermark embedding apparatus for embedding information including information on a copyright owner of an original digital content such as a still image comprising a single image and a moving image comprising continuous images, user identification information for discriminating a user who uses the original digital contents, rights information indicating rights to use the original digital content, use condition information indicating the use conditions of the original digital content, secret information required to use the original digital content, and copy control information on copy control of the original digital content (hereinafter. referred to as “watermark information”) in a state in which the image of the original digital contents is not easily perceived with respect to the original data content (the data embedded is called a digital watermark); and digital watermark detection apparatus for detecting thereafter, as required, a digital watermark from an image of a digital content in which the digital watermark is embedded. Typically, the digital content is distributed between the digital watermark embedding apparatus and the digital watermark detection apparatus. In the distribution process, the digital content could suffer from various attacks. This embodiment has robustness against possible trimming of a digital content as an attack during the distribution.

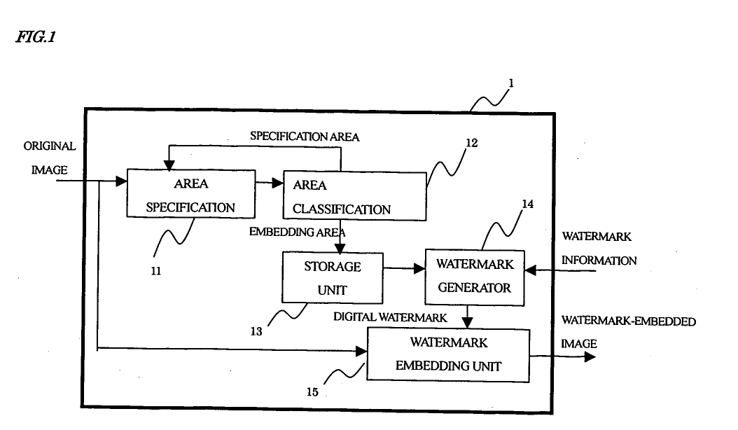

FIG. 1 is a functional block diagram of a digital watermark embedding apparatus 1.

An area specification unit 11 requires an image of original digital content as an input to specify a plurality of areas to the input image. The area specification unit 11 needs a specified area classified by an area classification unit 12 mentioned later to specify a plurality of areas to the specified area. The areas may be specified by displaying an image on a display unit (not shown) and having an operator designate the area to operate the digital watermark embedding apparatus. Or, an input image object may be automatically recognized and the area may be automatically specified based on a predetermined rule. Other specification methods may be used.

The area classification unit 12 requires areas from the area specification unit 11 as input to classify the areas into embedding areas where a digital watermark is embedded and specification areas where an area is specified. The area classification unit 12 stores in the storage unit 13 the embedding information including the position corresponding to the image in the classified embedding area, and size and shape of the area. The area classification unit 12 inputs the classified specification area to the area specification unit 11 as explained above.

A watermark generator 14 requires watermark information to be embedded as inputs to generate each digital watermark by way of a predetermined digital watermark generation system based on the embedding information of the image stored into the storage unit 13. A variety of digital watermark generation systems are available; any system may be used.

A watermark embedding unit 15 embeds each digital watermark into an image considering an image, each digital watermark generates by the watermark generator 14, and the embedding position of each digital watermark based on respective embedding information of the original image temporarily stored into the storage unit 13. The watermark embedding unit 15 outputs an image in which each digital watermark is embedded. A digital content including an image in which each digital watermark is embedded is distributed by way of media such as a network. The distributed digital content is hereinafter referred to as a distributed content.

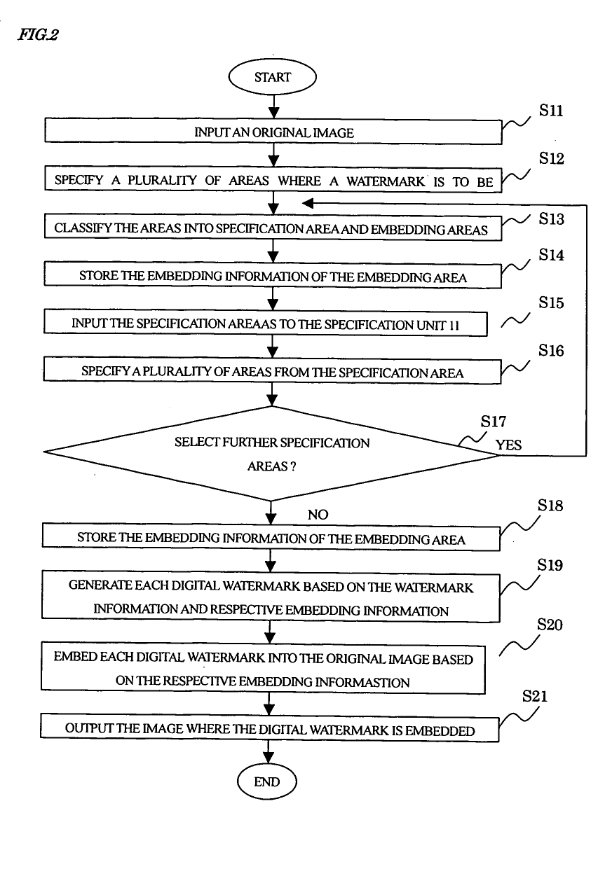

Operation of the digital watermark embedding apparatus 1 is described below referring to the flowchart of FIG. 2.

The image of original digital content is input to the area specification unit 11 (step S11). The area specification unit 11 specifies a plurality of areas in which a digital watermark is to be embedded in the input image (step S12). The areas may be specified by displaying an image on a display unit (not shown) and an operator designating the area to operate the digital watermark embedding apparatus, after selecting the area from the input image. Or, an input image object may be automatically recognized and the area may be automatically specified based on a predetermined rule. Other specification methods may be used.

Next, the area classification unit 12 classifies the specified areas into areas where a watermark is to be embedded in a smaller size (specification areas) and areas where the watermark is to be embedded into the areas of this size (embedding areas) (step S13). The classification may be done by displaying the images corresponding to the areas on a display unit (not shown) and by an operator classifying the areas to operate the digital watermark embedding apparatus. Alternatively, the areas may be automatically classified based on a predetermined rule. Other specification methods may be used.

Next, the embedding information concerning the embedding area classified in step 13, including the position corresponding to an input image and the rectangle size of the area, is stored into the storage unit 13 (step S14). The specification area classified is input to the area specification unit 11 (step S15).

Then, a plurality of areas are specified again to the specification area classified in step S13 (step S16). To allow overlapping of specification areas, one of the plurality of areas may be the specification area itself. The areas may be specified by displaying an image in the specification area on a display unit (not shown) and by an operator designating the area to operate the digital watermark embedding apparatus. Alternatively, an input image object in the specification area maybe automatically recognized and the area may be automatically specified based on a predetermined rule. Other specification methods may be used.

In case at least one area is selected as an area where the watermark is to be embedded in a smaller size (specification area) for each area specified in step S16, execution returns to step S13 and area classification is made again. Otherwise, execution proceeds to the next step S18 (step S17).

Each area specified in step S16 is assumed as an embedding area and embedding information such as the position corresponding to the input image and rectangle size of the area is stored into the storage unit 13 (step S18).

Based on the watermark information specified by an operator and respective embedding information stored in the storage unit 13, each digital watermark is generated by way of a predetermined digital watermark generation system (step S19).

A watermark embedding unit 15 inputs an image and each digital watermark generated by the watermark generator 14. The watermark embedding unit 15 considers the embedding position of each digital watermark based on respective embedding information of the input image temporarily stored in the storage unit 13, and embeds each digital watermark in an input image (step S20).

The watermark embedding unit 15 outputs an image in which each digital watermark is embedded and outputs a digital content including an image in which each digital watermark is embedded to a recordable medium such as a storage medium or a network (step S21). In this way, the output digital content (distributed content) is distributed on the market.

An operator of the digital watermark detection apparatus 1 acquires at least part of the distributed content (hereinafter referred to as a detected image) after the content is output from the digital watermark embedding apparatus 1 and distributed. The operator at the digital watermark detection apparatus 1 acquires, by any means, respective embedding information corresponding to the detected image from the storage unit 13 of the digital watermark embedding apparatus 1, selects the possibly largest embedding area of the detected image based on the embedding information and detects the embedding area as a detection target. By doing so, it is possible to detect a digital watermark with the highest possible watermark detection accuracy.

According to the digital watermark embedding apparatus of the foregoing embodiment, it is possible to embed a watermark with higher detection accuracy of an entire image of a digital content or an image trimmed in a large area from the entire image than that of detecting the watermark from a small image area.

Examples of the embodiment will be described.

### EXAMPLE 1

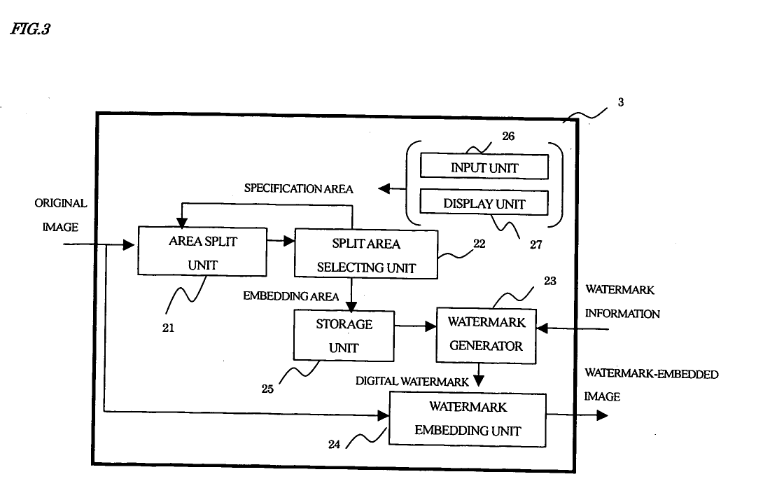

This example pertains to an algorithm which inhibits overlapping of digital watermarks. FIG. 3 is a functional block diagram of digital watermark embedding apparatus 3 according to the example 1.

The digital watermark embedding apparatus 3 can be implemented by, e.g., a personal computer, and comprises a general storage unit 25, an input unit 26 and a display unit 27.

An area splitting unit 21 splits an input image or a specified area from a split area selecting unit 22 into a predetermined number of areas by way of the display unit 27 and the input unit 26 based on an instruction from the user. Each split area is hereinafter called a block.

The split area selecting unit 22 selects a block to be further split based on the user's selection instruction among the blocks split by the area splitting unit 21. The selected block is input to the area splitting unit 21 again and further split. A block obtained by further splitting a block is also called a block. A block which is not selected stores the information on the position of the area and its size into the storage unit 25.

A watermark generator 23 uses the display unit 27 and the input unit 26 to input watermark information to be embedded based on an instruction from the user and generates a digital watermark depending on the size of each block stored in the storage unit 25.

A watermark embedding unit 24 arranges a digital watermark generated by the watermark generator 23 on an input image based on the position information of each block stored in the storage unit 25 and synthesizes the digital watermark and the image to generate an image in which the digital watermark is embedded.

While each digital watermark is arranged by the watermark embedding unit 24 in this example, the watermark generator 23 may arrange each digital watermark based on respective position information and generate a digital watermark image. Then the watermark embedding unit 24 may synthesize the original image and the digital watermark image.

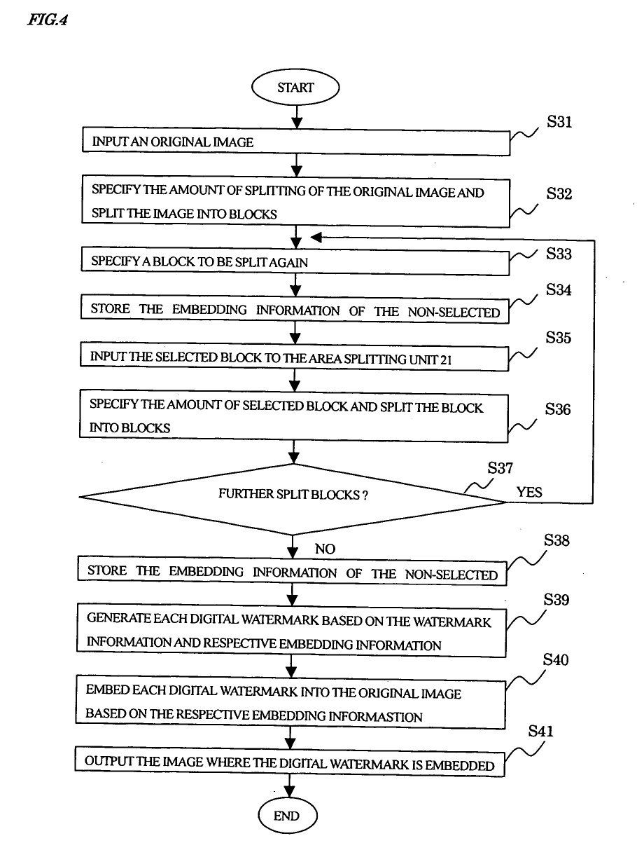

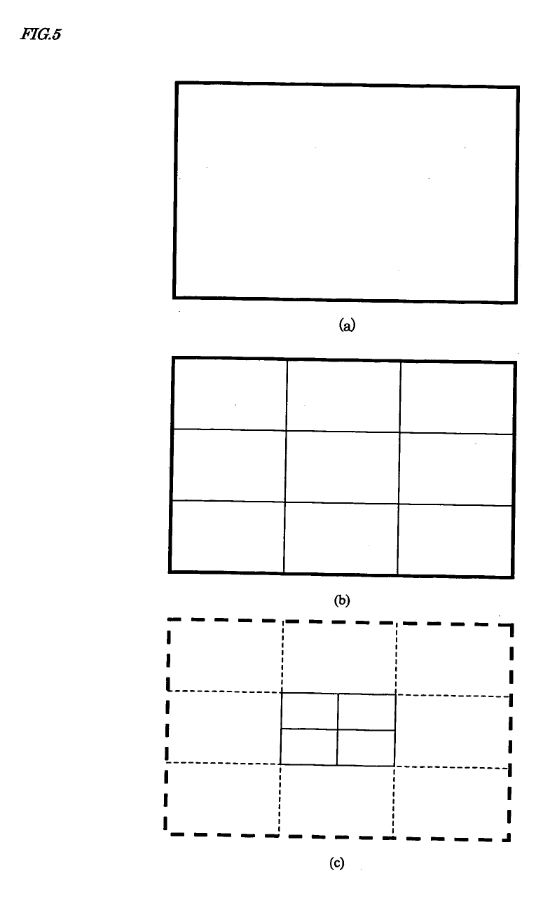

Next, the operation of the digital watermark embedding apparatus of the example is described below referring to the flowchart of FIG. 4 and illustrations of an input image in FIGS. 5(a)-5(c).

First, an input image (FIG. 5(a)) is input to the area splitting unit 21 (step S31). The operator uses the display unit 27 and the input unit 26 to specify the amount of splitting of the input image. The input image is equally split into the number specified by the area splitting unit 21 (step S32). For example, when the amount of splitting is set to 3×3, the input image is split into three blocks horizontally and three blocks vertically, into nine blocks in total, as shown in FIG. 5(b).

The operator then uses the display unit 27 and the input unit 26 to specify, from among all split blocks, a block to be split again (step S33). The split area selecting unit 22 stores into the storage unit 25 the embedding information indicating the position and size of a non-selected block in the input image (step S34). The split area selecting unit 22 inputs the block to be split again to the area splitting unit 21 (step S35).

The area splitting unit 21 designates the division number of the selected block and splits the block(s) in the number specified by the operator again (step S36). For example, when the amount of splitting is set to 2×2, the block is split into two by two (four) blocks horizontally and vertically, as shown in FIG. 5(c). To further split the blocks, execution returns to step S33. To stop splitting the blocks, execution proceeds to step S38 (step S37).

The split area selecting unit 22 stores into the storage unit 25 the embedding information indicating the position and size of a non-selected block in the input image (step S38).

The operator inputs watermark information to be embedded into the watermark generator 23 (by using the display unit 27 and the input unit 26 ). Depending on the size of each block stored in the storage unit 25, each digital watermark is generated (step S39). Each digital watermark generated by the watermark generator 23 is arranged and embedded into the input image based on the position information of each block stored in the storage unit 25 (step S40). In this way, the image in which a digital watermark is embedded is output and a distributed content including the image is stored into a recording medium and then output (step S41).

The digital watermark embedding apparatus 3 of this example operates as described above. While the amount of splitting in the area splitting unit 21 is specified by the operator, the amount of splitting may be previously fixed. While the operator specifies a block to be split in the split area selecting unit 22, a predetermined rule, such as selecting 3 by 3 central blocks twice (repeated twice), may be used to automatically select a target block.

According to the example 1, it is possible to embed a watermark with higher detection accuracy of an entire image of a digital content or an image trimmed in a large area from the entire image than that of detecting the watermark from a small image area.

### EXAMPLE 2

The second example is described next.

The digital watermark embedding apparatus 3 of the example 1 arranges digital watermarks so that they will not overlap each other. In the second example, digital watermarks may overlap each other.

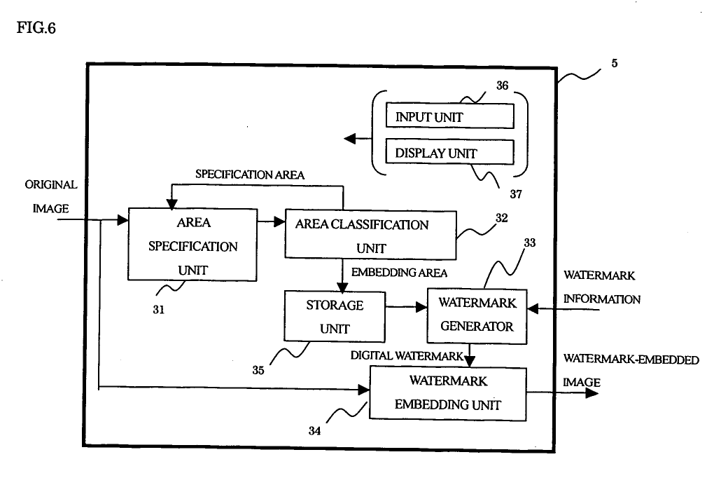

FIG. 6 is a functional block diagram of a digital watermark embedding apparatus 5 according to this example.

The digital watermark embedding apparatus 5 can be can be implemented by, e.g., a personal computer, and comprises a general storage unit 35, an input unit 36 and a display unit 37.

An area specification unit 31 specifies a plurality of areas (each area is hereinafter referred to as a block) from an input image or areas from an area classification unit 32 by using the display unit 37 and the input unit 36 based on an instruction from the user.

The area classification unit 32 classifies the blocks specified by the area specification unit 31 into blocks in which areas are to be further specified and blocks in which a digital watermark is to be embedded, based on an instruction from the user.

A block in which areas are to be further specified is input to the area specification unit 31 again and a plurality of areas are specified again to this block. Concerning a block in which a digital watermark is to be embedded, its position information and size in the input image are stored into the storage unit 35.

A watermark generator 33 uses the display unit 37 and the input unit 36 to input watermark information to be embedded based on an instruction from the operator, and generates digital watermarks based on the size of each block in the input image stored in the storage unit 35 and the number of blocks, in the case the number of blocks is four or more. The reason the number of blocks is considered when it is four or more is described later.

A watermark embedding unit 34 arranges a digital watermark generated by the watermark generator 33 on an input image based on the position information of each block stored in the storage unit 25 and synthesizes the digital watermark and the image to generate an image in which the digital watermark is embedded.

While each digital watermark is arranged by the watermark embedding unit 34 in this example, the watermark generator 33 may arrange each digital watermark based on respective position information and generate a digital watermark image and the watermark information embedding unit 34 may synthesize the input image and the digital watermark image.

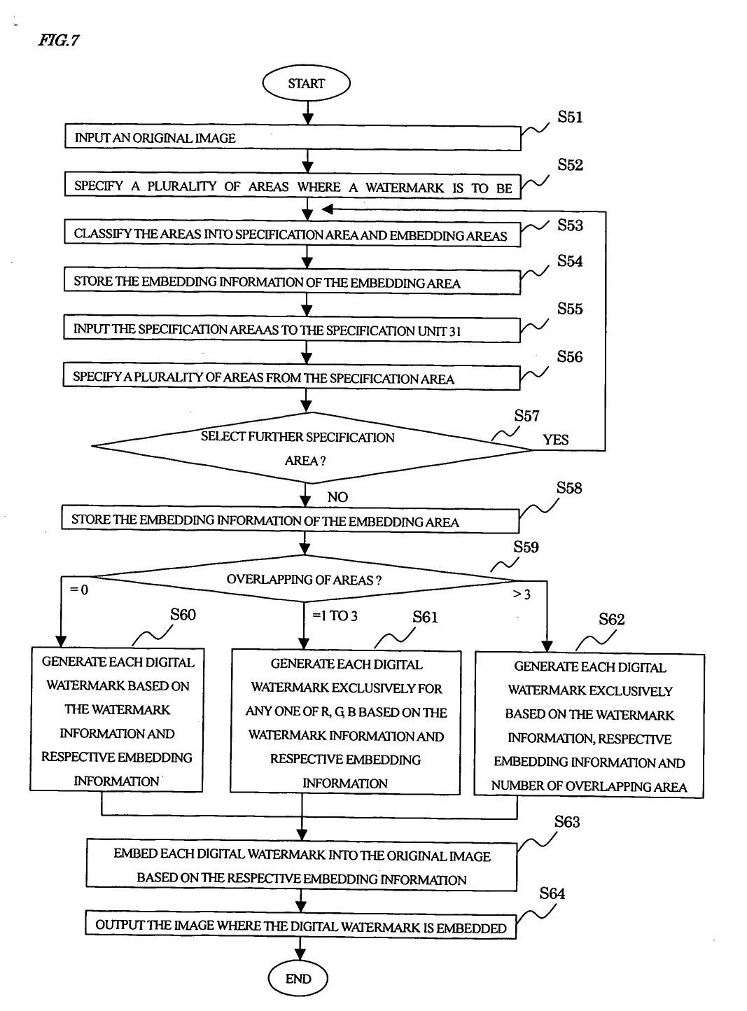

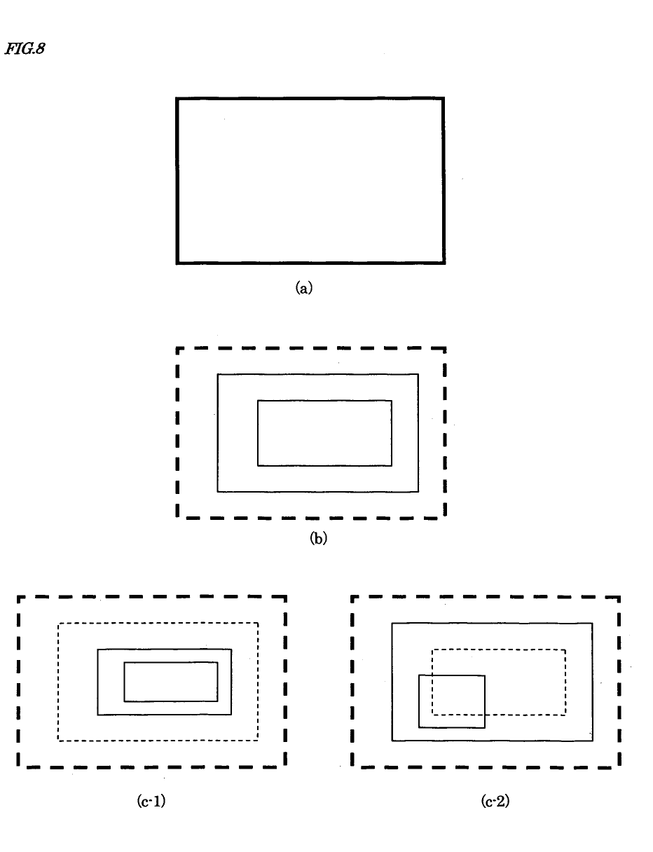

Operation of the digital watermark embedding apparatus 5 of the example is described below referring to the flowchart of FIG. 7 and the illustrations of an input image in FIGS. 8(a)-8(c-2).

First, an input image (FIG. 8A) is input to the area specification unit 31 (step S51).

The operator uses the display unit 27 and the input unit 26 to specify a plurality of blocks of an input image in which a watermark is to be embedded (step S52). For example, the operator specifies two blocks as shown in FIG. 8(b).

The operator uses the display unit 37 and the input unit 36 to classify the specified blocks into blocks to be classified again and blocks in which a digital watermark is to be embedded (step S53). The area classification unit 32 stores the embedding information indicating the position of the watermark and its size in the input image into the storage unit 35 (step S54)

The area classification unit 32 inputs the blocks to be specified again to the area specification unit 31 based on this specification (step S55).

In the area specification unit 31, the operator specifies a plurality of (new) blocks out of the block(s) (step S56). In this specification, there may be a case in which all blocks overlap each other (FIG. 8(c-1) and a case in which some of the blocks overlap each other (FIG. 8(c-2)). This will be described later.

To specify a specified block again, execution returns to step S53. Otherwise, execution proceeds to step S58 (step S57).

The area classification unit 32 stores the embedding information indicating the position of the watermark and its size in the input image into the storage unit 35 (step S58)

The operator inputs watermark information to be embedded to the watermark generator 33 (by using the display unit 37 and the input unit 36) to generate each watermark in each block stored in the storage unit 35. In case the digital watermarks overlap each other as mentioned earlier, it is difficult to detect the digital watermark. Two examples are given below to overcome this difficulty.

In case up to three blocks overlapping each other are specified and the images are color images, one of the color components R, G and B which constitutes a single pixel of the color image should be exclusively allocated to each area. R, G and B can be handled as independent data for one pixel, so that even in case a digital watermark is embedded in each block, the digital watermarks can be extracted independently. Taking advantage of this feature, each digital watermark generated by the watermark generation unit 33 is embedded into any one of R, G and B in the original image. This allows independent detection of digital watermarks although the images overlap each other.

In case four or more blocks are specified or the image is a monochrome image, the above method is not applicable. Instead of using R, G and B, the following method is used to independently embed digital watermarks although the blocks overlap each other.

Between the overlapping blocks, only the lines in vertical direction per number of blocks are exclusively allocated to each block. For example, in case three blocks overlap each other, the lines 1, 4, 7, . . . are allocated to the first block, the lines 2, 5, 8, . . . are allocated to the second block, and the lines 3, 6, 9, . . . are allocated to the third block. This allows digital watermarks to be detected independently of each other. Note that, in this case, the number of lines actually used for the watermark is one third that of the original block size, so that it is necessary to generate a digital watermark assuming that one third of the block sizes are block in which digital watermark can be embedded.

Following step S58, it is checked whether the blocks stored in the storage unit 35 overlap each other and whether the number of overlapping blocks is four or more (step S59). In case the blocks do not overlap each other, respective digital watermarks are generated based on the input watermark information and embedding information for each area stored in the storage unit 35 (step S60). In case the number of overlapping blocks is one to three, target watermark information is input to the watermark generator 33 and a respective watermark for each block stored in the storage unit 35 is exclusively generated for any of R, G and B (step S61). In case the number of overlapping blocks is four or more, a respective digital watermark is generated based on the input watermark information, the embedding information for each area stored in the storage unit 35, and the number of overlapping areas (step S62).

The digital watermarks generated by the watermark generator 33 are arranged based on the position information of each block stored in the storage unit 35 and embedded into the input image (step S63).

In this way, a digital content including the image in which a digital watermark is embedded is stored on a recording medium and output therefrom (step S64).

The digital watermark embedding apparatus 5 of this example operates as described above.

According to the example 2 described above, it is possible to embed a watermark with higher detection accuracy of an entire image of a digital content or an image trimmed in a large area from the entire image than that of detecting the watermark from a small image area.

It is also possible to embed digital watermarks so as to allow independent detection of digital watermarks even when the digital watermarks overlap with other.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. A method of embedding a digital watermark, comprising:
specifying a plurality of areas on an original image;
classifying the specified areas into at least one of embedding areas in which watermark information is to be embedded and at least one of a first specification area in which an area is to be specified;
specifying a plurality of areas on said first specification area;
classifying at least one of the specified areas into one of the embedding areas;
inputting watermark information and generating digital watermarks based on a size and a shape of said embedding areas; and
embedding said digital watermarks into the original image.

2. The method according to claim 1, wherein said embedding areas overlap each other.

3. The method according to claim 1, wherein said embedding areas inhibit the areas from overlapping each other.

4. The method according to claim 1, further comprising:
specifying a plurality of areas on a second specification area not classified into an embedding area.

5. The method according to claim 2, wherein said digital watermarks are generated for colors different from each other among three primary colors (R, G, B) when a number of digital watermarks generated is three or less.

6. The method according to claim 2, wherein said digital watermarks are generated assuming a value obtained by dividing a size of each of said embedding areas by n as the size of the area when a number of digital watermarks generated in said digital watermark generation step is n (n being an integer).

7. A digital watermark embedding apparatus, comprising:
a first specification unit configured to specify a plurality of areas on an original image;
a first classification unit configured to classify the specified areas specified by said first specification unit into at least one of embedding areas in which watermark information is to be embedded and at least one of a first specification area in which an area is to be specified;
a second specification unit configured to specify a plurality of areas on said first specification area classified by said first classification unit;
a second classification unit configured to classify at least one of the specified areas specified by said second specification unit into an embedding area;
a digital watermark generator configured to input watermark information and to generate digital watermarks based on a size and shape of said embedding areas; and
an embedding unit configured to embed said digital watermarks generated by said digital watermark generator into the original image.

8. The apparatus according to claim 7, wherein said embedding areas overlap each other.

9. The apparatus according to claim 7, wherein said embedding areas inhibit the areas from overlapping each other.

10. The apparatus according to claim 7, further comprising:
a third specification unit configured to specify a plurality of areas on one of the specified areas specified by said second specification unit and not classified into an embedding area by said second classification unit.

11. The apparatus according to claim 8, wherein said digital watermarks is generated for colors different from each other among three primary colors (R, G, B) when a number of digital watermarks generated is three or less.

12. The apparatus according to claim 8, wherein said digital watermarks are generated assuming a value obtained by dividing a size of each said embedding area by n as the size of the area when a number of digital watermarks generated in said digital watermark generation step is n (n being an integer).

13. A computer-executed program comprising:
a first program code for specifying a plurality of areas on an original image;
a second program code for classifying the specified areas into at least one of embedding areas in which watermark information is to be embedded and at least one of a first specification area in which an area is to be specified;
a third program code for specifying a plurality of areas on said first specification area;
a fourth program code for classifying at least one of the specified areas into one of the embedding areas;
a fifth program code for inputting watermark information and generating digital watermarks based on a size and a shape of said embedding areas; and
a sixth program code for embedding said digital watermarks into the original image.

14. The program according to claim 13, wherein said embedding areas overlap each other.

15. The program according to claim 13, wherein said embedding areas inhibit the areas from overlapping each other.

16. The program according to claim 13, further comprising:
specifying a plurality of areas on a second specification area not classified into an embedding area.

17. The program according to claim 14, wherein said digital watermarks are generated for colors different from each other among three primary colors (R, G, B) when a number of digital watermarks generated is three or less.

18. The program according to claim 14, wherein said digital watermarks are generated assuming a value obtained by dividing a size of each of said embedding areas by n as the size of the area when a number of digital watermarks generated in said digital watermark generation step is n (n being an integer)
